(19) United States
(12) Patent Application Publication
(10) Pub. No.: US 2025/0272881 A1
(43) Pub. Date: Aug. 28, 2025

(54) AUTOENCODER FOR RADAR DATA COMPRESSION

(71) Applicant: Infineon Technologies AG, Neubiberg (DE)

(72) Inventors: Muhammad Hassan, München (DE); Jürgen Schäfer, Oberhaching (DE)

(21) Appl. No.: 18/584,317

(22) Filed: Feb. 22, 2024

(51) Int. Cl. G06T 9/00; G01S 13/89

(52) U.S. Cl. CPC G06T 9/002; G01S 13/89; G06T 9/001

(57) ABSTRACT

A radar system includes a radar transmitter to transmit a transmit radar signal into a field. A radar receiver receives a receive radar signal in response to the transmit radar signal and generates received radar data based on the receive radar signal. A neural network compression logic is coupled to the radar receiver and has a multi-layer perceptron architecture. The neural network compression logic is trained to compress the received radar data to generate a compressed radar cube. A memory is coupled to the neural network compression logic and is configured to store the compressed radar cube. A neural network de-compression logic is coupled to the memory. The neural network de-compression logic is trained to de-compress the compressed radar cube to generate de-compressed radar data. A target detection logic is configured to detect whether a target is present in the field based on the de-compressed radar data.

### FIELD

The present disclosure relates to radar systems, and more particularly to radar systems that use data compression and data decompression during processing.

### BACKGROUND

Radar (RAdio Detection And Ranging) systems use radio waves to determine the location and/or velocity of targets in a field. Historically, radar has been used to detect aircraft, ships, spacecraft, guided missiles, and terrain, among others. In more recent times, radar has also been used to study and/or predict weather formations, and has been used in collision-detection and/or collision-avoidance in motor vehicles. A radar system includes a transmitter to produce electromagnetic waves in the radio or microwave domain, a receiver to receive those waves after they bounce back from one or more targets in a field, and a processor to determine properties of the targets. The electromagnetic waves from the transmitter can be pulsed or continuous, and reflect off the target and return to the receiver, giving information about the target's location and/or velocity relative to the radar system.

### SUMMARY

According to various embodiments, a radar system is provided. The radar system includes a radar receiver configured to receive a receive radar signal in response to a transmit radar signal and generate received radar data corresponding to a radar cube based on the receive radar signal. A neural network compression logic coupled to the radar receiver and having a multi-layer perceptron architecture, wherein the neural network compression logic is trained to compress the received radar data to generate a compressed radar cube; a memory coupled to the neural network compression logic and configured to store the compressed radar cube; a neural network de-compression logic coupled to the memory and having a multi-layer perceptron architecture, wherein the neural network de-compression logic is trained to de-compress the compressed radar cube to generate de-compressed radar data; and a target detection logic configured to detect whether a target is present in the field based on the de-compressed radar data.

A method, comprising: transmitting a transmit radar signal into a field; receiving a receive radar signal in response to the transmit radar signal and generating received radar data corresponding to a radar cube based on the receive radar signal; compressing the received radar using a neural network compression logic having a multi-layer perceptron architecture, wherein the neural network compression logic is trained to generate a compressed radar cube; storing the compressed radar cube in memory; de-compressing the compressed radar cube using a neural network de-compression logic having a multi-layer perceptron architecture, wherein the neural network de-compression logic is trained to generate de-compressed radar data; and detecting whether a target is present in the field based on the de-compressed radar data.

### BRIEF DESCRIPTION OF THE DRAWINGS

In the drawings, similar reference characters generally refer to the same parts throughout the different views. The drawings are not necessarily to scale, but rather emphasis is instead generally placed upon illustrating the principles of the invention. In the following description, various aspects are described with reference to the following drawings, in which:

FIG. 1 illustrates a radar system in accordance with some aspects of the present disclosure.

FIG. 2 illustrates a multi-zone radar system in accordance with some aspects of the present disclosure.

FIG. 3 shows a depiction of a neural network for implementing Artificial Intelligence-based (Al-based) compression and decompression.

FIG. 4 shows another depiction of a neural network for implementing Al-based compression and decompression.

FIG. 5 illustrates a method in flow chart format according to some aspects of the present disclosure.

FIG. 6 illustrates a method in flow chart format according to some aspects of the present disclosure.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

Radar is becoming more and more ubiquitous in modern automotive systems as well as in other areas of society. Some vehicles can use a long-distance radar sensor in the front of the vehicle to help to avoid head-on collisions, and/or can use close-proximity radar sensors near the front bumper, rear bumper, and corners of the vehicle, respectively, to aid in low-speed maneuverability operations, such as parking. As the number of radar sensors increases and/or the resolution of each sensor increases, the resulting trend is that modern vehicles allocate greater amounts of data storage and data processing to radar systems, compared to conventional vehicles. While this trend helps to provide the user with greater safety and more convenience, it also adds expense to the vehicle because additional on-board memory is needed. To help achieve a better cost versus performance point than other systems, aspects of the present disclosure fuse data from multiple radar sensors and utilize an auto encoder/decoder neural network to compress and decompress radar data as the data is processed by the radar system. This compression and decompression reduces the amount of memory needed for radar systems, and also can reduce latency because smaller amounts/bits of data are transferred through the system due to the compression. Thus, this compression and decompression helps provide lower cost and higher performance for radar systems.

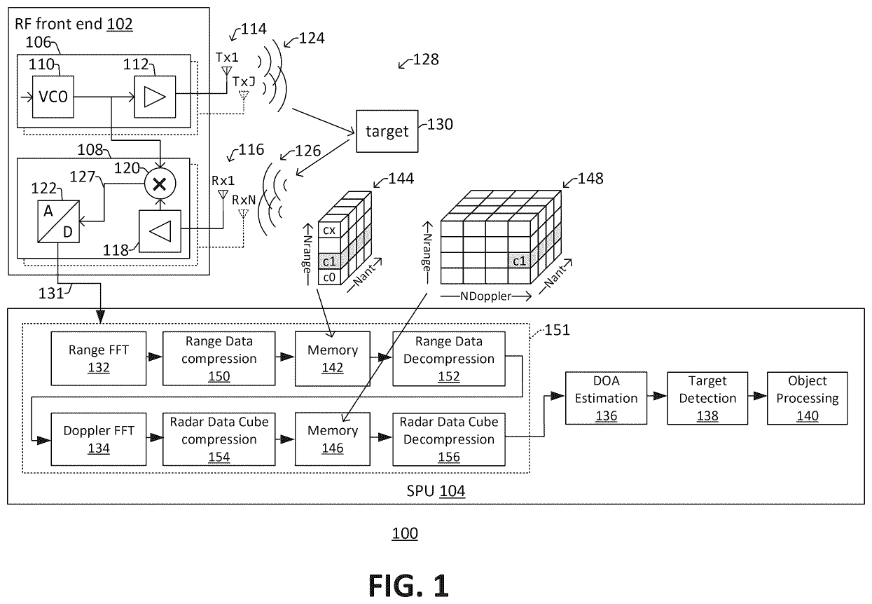

FIG. 1 illustrates a radar system 100 in accordance with some embodiments. The radar system 100 includes a radio frequency (RF) front end 102 and a signal processing unit (SPU) 104, such as a baseband and/or other processor, which is downstream of the RF front end 102. The RF front end 102 includes a transmission path 106 and a reception path 108. The transmission path 106 includes a voltage controlled oscillator (VCO) 110 and a transmission amplifier 112, and has an output that is coupled to a transmission antenna 114. The reception path 108 has an input that is coupled to a reception antenna 116, and includes a reception amplifier 118, a mixer 120, and an analog-to-digital converter (ADC) 122. In more typical cases, there are multiple transmission paths and J transmission antennas (where J is any positive integer), and multiple reception paths and N reception antennas (where N is a positive integer, and N can be greater than, less than, or equal to J). The reception antennas are typically spaced apart at equal distances from one another.

During operation, the VCO 110 and transmission amplifier 112 generate a radar signal, which is transmitted as electromagnetic waves 124 into a field 128 via the transmission antennas 114. In frequency modulated continuous wave (FMCW) examples, the transmitted waves 124 have a frequency that ramps in time for x ramps transmitted in x time windows, respectively. The transmitted waves 124 are achieved by performing a frequency modulation of a carrier frequency, Fc. In other modulation examples, the transmitted waves 124 can includes a series of discrete pulses.

The reception antennas 116 then “listen” for received pulses 126 (or echoes) to determine the location, velocities, and/or directions of one or more targets 130 in the field. Received waveforms or “echoes” (e.g., 126) reflect off the target 130 in the field, and are received by the reception antennas 116 and the reception amplifier 118. Because each target in the field generates a different echo, each reception antenna sees a superposition of all received waveforms. The mixer 120 mixes the transmitted radar signal and the received waveforms and thereby multiplies these waveforms together to provide a mixed signal 127. This mixed signal 127 includes a beat frequency, which is a mixture of the frequencies of the received waveforms. Thus, this beat frequency corresponds to time delays for the various targets, wherein these time delays correspond to the ranges to the various targets, respectively. The beat frequency is much less than the carrier frequency, Fc; or the central frequency of the sweep. The beat frequency is then sampled by the ADC 122 to generate a digital radar signal 131.

The SPU 104 performs a first fast Fourier transform (FFT) 132 (which may also be referred to as a Range FFT) and a second FFT 134 (which may also be referred to as a Doppler FFT). The Range FFT 132 is initially performed on the digital radar signal 131 and the first FFT results are stored in memory 142. The Range FFT 132 separates the individual beat frequencies in the digital radar signal 131, which directly leads to a first FFT result with a number of range bins, with each range bin corresponding to a different range of ranges/distances at which targets can be found. In FMCW radar systems, this FFT process is repeated over every ramp of x ramps (e.g., from ramp C0 . . . to ramp Cx), and the FFT results are stored in memory 142 for each of x ramps. When all the x ramps are complete, a block of data representing the full field range data is stored in memory (see 144). The results in each range bin may look similar for the various frequency ramps in that range bin, but, since the individual ramps C0, C1, . . . , Cx are separated in time, the samples in a given range bin carry a subtle phase difference induced by the Doppler shift of the various objects (e.g., a time delay due to a slight change in range for an object caused by the object moving by distance v*t, where v is the velocity of the object and t is time).

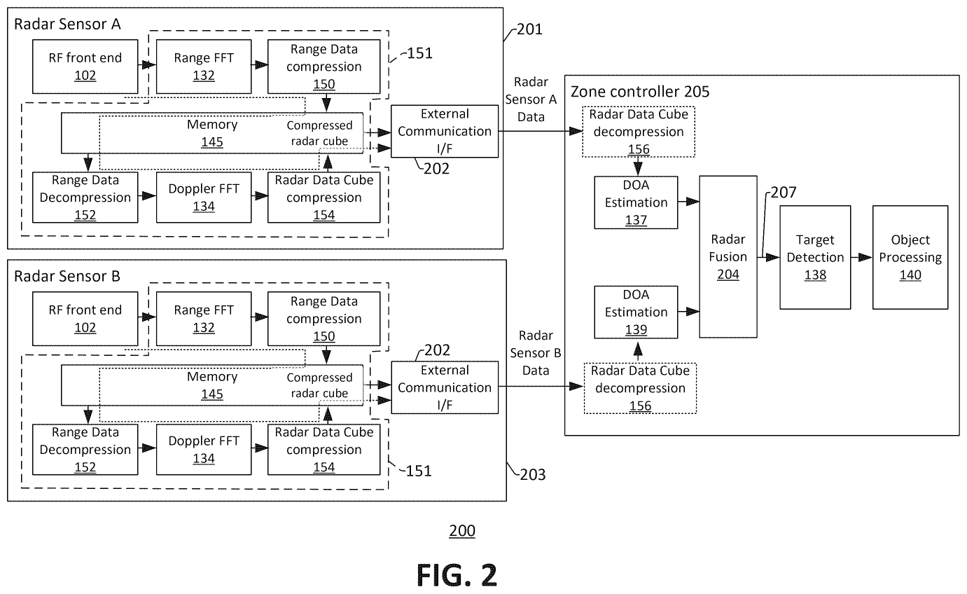

To recover Doppler information (e.g., velocity information about each target), the second FFT 134—or “Doppler FFT”—is performed on the co-located bins (represents the corner turn or transpose operation) from all ramps. The Doppler information is a stream of complex values stored in memory 146. Each complex value represents the magnitude (amplitude) and phase of the digital radar signal 131 at a respective range and Doppler coordinate pair. Note the stream of complex values from 134 is not simply a two-dimensional range-Doppler map but has a third dimension and may thus be thought of as a 3D radar cube (see 148) having Range axis, Doppler axis, and a receive antennas axis (Nrx). Thus, the 3D radar cube 148 includes received powers from various objects in a field, and can be plotted according to range bins, Doppler bins; and NRx receive antennas. Memories 142 and 146 can be pipelined (e.g., memory 146 is downstream and/or in series with memory 142), or can be a single memory (e.g., see FIG. 2), depending on the implementation.

The 3D radar cube 148 (and/or vectors from the 3D radar cube) is provided to a Direction of Angle (DOA) estimation logic 136. The DOA estimation logic 136 determines an angle/direction to the target 130 in the field. A target detection logic 138, and an object processing logic 140 are also arranged downstream of the DOA estimation logic 136, and detect whether a target is present in the field based on the FFT data.

In some embodiments of the present disclosure, the inventors have appreciated that Range FFT 132 and Doppler FFT 134 could potentially result in a 3D radar cube 148 that requires a very large external memory. This could increase the overall bill of materials for the radar system, and could also impact performance due to latency arising due to the large amount of data being processed. To reduce the amount of data in the 3D radar cube 148 and thereby limit material costs and latency in the system, some aspects of the present disclosure contemplate use of a radar neural network logic 151 that includes neural network compression logic (e.g., 150, 154) and neural network decompression logic (e.g., 152, 156).

In particular, FIG. 1's radar system includes range neural network compression logic 150, range neural network de-compression logic 152, radar cube neural network compression logic 154, and radar cube neural network de-compression logic 156. The range neural network compression logic 150 has an input coupled to Range FFT 132 and an output coupled to memory 142. The range neural network compression logic 150 is trained to compress the Range data from Range FFT 132 to generate compressed Range data stored in memory 142. The Range neural network de-compression logic 152 has an input coupled to the memory 142 and an output coupled to the Doppler FFT 134. The Range neural network de-compression logic 152 is trained to de-compress the compressed Range data to generate de-compressed radar data to the Doppler FFT 134. The radar data cube neural network compression logic 154 has an input coupled to an output of the Doppler FFT 134 and an output coupled to memory 146. The radar data cube neural network compression logic 154 is trained to compress the 3D radar data cube from the Doppler FFT 134 to generate a compressed 3D data cube stored in memory 146. The radar data cube neural network de-compression logic 156 is trained to de-compress the compressed 3D radar cube data to generate de-compressed radar cube data to the DOA estimation logic 136, target detection logic 138, and/or object processing logic 140, which detect whether a target is present in the field based on the de-compressed radar cube data.

Because this radar system 100 includes compression logic (e.g., 150 and 154) and de-compression logic (152, and 156), this radar system 100 reduces memory and latency compared to previous approaches. Also, this approach can be implemented as an extension to existing radar systems by simply adding specific execution pipelines, e.g., vectorized activation function implementations, and so on. Further still, because the neural networks are Al-trained, the neural networks can be trained to cover specific radar sensor configurations and environments, where traditional compression algorithms are fixed over various environments. Therefore, this configuration offers good tradeoffs between performance and cost compared to previous approaches.

FIG. 2 shows another example of radar system 200, which includes multiple radar sensors that enable radar sensing concurrently over different zones of a vehicle or other system. In this example, the radar system 200 includes two radar sensors (e.g., Radar Sensor A 201, and Radar Sensor B 203), though any number of such radar sensors could be included. These radar sensors can transmit and receive radar signals and electromagnetic waves concurrently, and processing of the presence of targets, direction to any targets, and classification of objects is carried out concurrently for the sensors in a zone controller 205. Somewhat akin to FIG. 1's radar system, each radar sensor includes an RF front end 102, a Range FFT logic 132, Doppler FFT logic 134, Range neural network compression logic 150, Range neural network de-compression logic 152, radar data cube neural network compression logic 154, radar data cube neural network de-compression logic 156, and external interface block 202. Rather than separate pipelined memories 142, 146 as illustrated in FIG. 1, each radar sensor in FIG. 2 includes a single memory 145 that is shared between the various components using that radar sensor.

During operation of each sensor, radar data from the RF front end 102 is processed by the Range FFT logic 132 to generate Range FFT data. The Range FFT data is then compressed by the Range neural network compression logic 150, and compressed Range data is stored in memory 145. Because the Range data is compressed, the memory 145 for each sensor can be smaller and/or less expensive than other approaches. The Range neural network de-compression logic 152 then decompresses the Range data from memory 145, and the Doppler FFT logic 134 performs a second (Doppler) FFT to provide 3D radar cube data. The radar data cube neural network compression logic 154 then compresses the 3D radar cube data and writes the result to memory 145.

Notably in FIG. 2, the compressed 3D radar cube from the first radar sensor 201 and second radar sensor 203 are provided to a single zone controller 205. The zone controller 205 first de-compresses the compressed 3D cube data. The de-compressed 3D cube data is then provided to the first and second DOA estimation logics 137, 139, respectively. The data from the DOA estimation logics 137, 139 is then fused at a radar fusion block 204. Target detection 138 and object processing 140 is then carried out on the fused radar data 207 from the multiple radar sensors. The fused data is then de-compressed by radar cube decompression logic 156 in the zone controller 205.

Because the target detection logic 138 and object processing logic 140 operate on fused radar data 207, the amount of data flowing through the radar system at any given time is reduced compared to previous approaches. For example, in some examples, the compression ratio achieved by the Range neural network compression logic 150 can be approximately 1:2 and/or 1:3, meaning that the number of bits used to store the Range data is reduced by a factor or 2 or a factor of 3 compared to if no compression was used. Similarly, the compression ratio achieved by the radar data cube neural network compression logic 154 can be approximately 1:2 and/or 1:3. This compression thereby significantly reduces the amount of memory required for the system, and also reduces latency because much lower data rates are needed to support internal data transfer in the system. For example, in the absence of compression, a radar system with 1024 Range bins, 128 Doppler bins, and 16 antennas can manifest in a 3D radar cube size of 8 megabytes (MB), and a corresponding data rate of 1.68 gigabits per second (Gbps) at 25 frames per second (FPS). If the same radar system made use of a compression ratio of 1:2 the 3D radar cube size would drop to 4 MB and a corresponding data rate of 0.84 Gbps at 25 frames per second, with no little or no significant impact seen on DoA performance.

In contrast to the example of FIG. 1 where two distinct/pipelined memories 142, 146 were used to store the results of FFT processing 132, 134, FIG. 2's example uses a single memory to store the results of the Range FFT 132 and Doppler FFT 134. Both approaches are contemplated as falling within the scope of the present disclosure, and can be used interchangeably. Similarly, in some embodiments consistent with FIG. 1, the first FFT 132 and second FFT 134 correspond to separate FFT circuit instantiations arranged in series on an integrated circuit, and which collectively correspond to a FFT circuit. In other embodiments consistent with FIG. 2, however, first FFT 132 and second FFT 134 can be a single FFT circuit with surrounding circuitry to re-route data through the single FFT circuit multiple times.

In some instances, the radar sensors and/or zone controller can be included on one or more integrated circuits and/or with discrete devices. Such integrated circuits can include a single monocrystalline silicon substrate arranged within a package, and can include transistors in the substrate and interconnect wires (e.g., copper lines) over the substrate coupling transistors to one another within the package. The integrated circuits can also multiple substrates that are stacked vertically over one another to establish a three-dimensional IC, and/or can include multiple chips on a printed circuit board or otherwise electrically coupled together. The radar sensors can similarly be included on an integrated circuit, and/or can be discrete high frequency (e.g., radio frequency (RF)) devices. Further, in addition to and/or in place of monocrystalline silicon substrates, in some implementations substrates can be Gallium Arsenide (GaAs), Indium Gallium Arsenide, and/or III/V semiconductor materials, among others. Some aspects of the radar sensors and/or zone controller can also be realized as machine readable instructions that are executed by a microprocessor.

Training data for the Al-based radar systems 100, 200 (which is for example implemented by a neural network) may be collected in a laboratory setup with highly accurate radar data (measured using a more accurate radar sensor than the one used in the field). Using these data, the Al-based compression neural networks (e.g., 150, 154) and de-compression neural networks (e.g., 152, 156) may be trained and then deployed. Al-based compression and de-compression neural networks trained in this manner may achieve lower latency and lower memory requirements than other approaches.

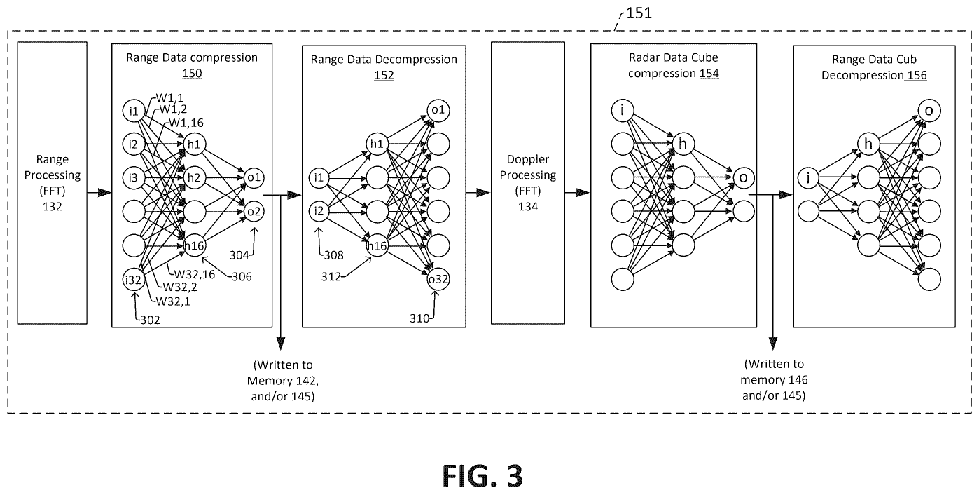

FIG. 3 shows a radar neural network logic 151 for implementing an Al-based compression and decompression. The radar neural network logic 151 can be consistent with some examples of radar neural network logic 151 in FIGS. 1-2. In particular, the radar neural network logic 151 includes range data compression logic 150, range data de-compression logic 152, radar data cube compression logic 154, and radar data cube de-compression logic 156. Each neural network compression logic (150, 154) and de-compression logic (152, 156) can have a multi-layer perceptron (MLP) architecture that includes an input node layer, output node layer, and one or more hidden node layers and/or transition layers arranged between the input node layer and output node layer. The nodes of each layer are connected to each other, and the strength of their connections to one another is assigned a value based on their strength—for example, inhibition (e.g., maximum being −1.0) or excitation (e.g., maximum being +1.0). If the value of the connection is high, then it indicates that there is a strong connection, whereas is the value of the connection is low, then it indicates there is a weak connection, such that the nodes represent various weighting applied to the data. Thus, the Range neural network compression logic 150 includes an input layer 302 coupled to an output of the range FFT 132, an output layer 304 coupled to the memory 142 and/or 151, and a hidden layer 306 coupled between the input layer 302 and the output layer 304. The hidden layer 306 has fewer nodes (e.g., hidden nodes h1, . . . , h16) than the input layer (e.g., input nodes i1, . . . , i32) and more nodes than the output layer (e.g., output nodes o1, o2). Somewhat analogously, the neural network range data de-compression logic 152 includes an input layer 308 coupled to the memory 142 and/or 151, an output layer 310 coupled to the Doppler FFT 134, and a hidden layer 312 coupled between the input layer 308 and the output layer 310. The hidden layer 312 has more nodes than the input layer 308 and fewer nodes than the output layer 310.

The mathematical view for encoding between the input layer 302 of the range data compression logic 150 and hidden layer 306 of the range data compression logic 150 is illustrated below in equation (1).

$$( \begin{matrix}h 1 \\ h 2 \\ … \\ h 16\end{matrix} ) = tan h ( ( \begin{matrix}w 1 , 1 & w 2 , 1 & w 3 , 1 & … & w 32 , 1 \\ w 1 , 2 & w 2 , 2 & w 3 , 2 & … & w 32 , 2 \\ w 1 , 16 & w 2 , 16 & w 3 , 16 & … & w 32 , 16\end{matrix} ) * ( \begin{matrix}i 1 \\ i 2 \\ i 3 \\ … \\ i 32\end{matrix} ) + ( \begin{matrix}b 1 \\ b 2 \\ … \\ b 16\end{matrix} ) ) \qquad ( 1 )$$

As illustrated above, the values at the respective hidden nodes (h1., . . . , h16) are calculated by taking the hyperbolic tangent (tanh) of the input values (as vector i1, i2, . . . , i32) and multiplying them by the strengths/weights (w1,1, w2,1, . . . , w32,16) according to a matrix-vector multiplication. The vector product of the input value matrix and the strengths/weight vector is then added to a bias vector (b1, b2, . . . , b16). The bias vector is included for offsetting purposes. For example, in a simple example where the vector product is a line, the bias vector can shift the line in the x-direction or y-direction. During the training phase of the system, the bias vector is updated along with the weights/strengths. Then later when training is complete and the system is deployed, the bias vector typically remains static with the weights/strengths that were determined during training. Although an example using the tanh function is illustrated, other functions could also be used, such as sigmoid, rectified linear unit (ReLU), softplus, or Gaussian.

Direction of arrival processing, target detection, and/or object processing can then be carried out on the decompressed radar cube data output from 154. In cases were data from multiple sensors is fused, because the DoA, target detection, the data flowing through the radar system is reduced compared to previous approaches. For example, Table 1 below shows some example comparisons of the DOA error and accuracy for various numbers of targets in the field. In column 1, no compression is used. In column 2 (MLP_32_16_32), compression from 32 input nodes to 16 output nodes is used, followed by de-compression from 16 input nodes to 32 output nodes is used; while in column 3 (MLP_32_12_16_32), compression from 32 input nodes to 12 output nodes is used, followed by de-compression from 16 input nodes to 32 output nodes is used.

TABLE 1

| | | | Comp/Decompression | | Comp/Decompression | |
|---|---|---|---|---|---|---|
| | | | with MLP_32_{—} | | with MLP_32_12_{—} | |
| | No | | 16_32 | | 16_32 | |
| No. | compression | | (compression | | (compression | |
| of | DOA error & | | ratio 1:2) | | ratio ~1:3) | |
| targets | accuracy | | DOA error & accuracy | | DOA error & accuracy | |
| 1 | 0.21° | (99.1%) | 0.21° | (99.4%) | 0.24° | (98.9%) |
| 2 | 0.24° | (93.3%) | 0.24° | (93.2%) | 0.28° | (92.1%) |
| 3 | 0.29° | (90%) | 0.30° | (88.7%) | 0.35° | (87.9%) |

As can be seen above, compared to no compression of column 1, MLP32_16_32 of column 2 provides a compression ratio of 1:2, meaning that MLP32_16_32 cuts the amount of data bits by 50%, and still has a very similar DOA error and accuracy. Thus, memory requirements and latency can be reduced significantly. Similarly, compared to no compression of column 1, MLP32_12_16_32 of column 3 provides a compression ratio of approximately 1:3, meaning that MLP32_12_16_32 cuts the amount of data bits by two thirds, and still has a very similar DOA error and accuracy.

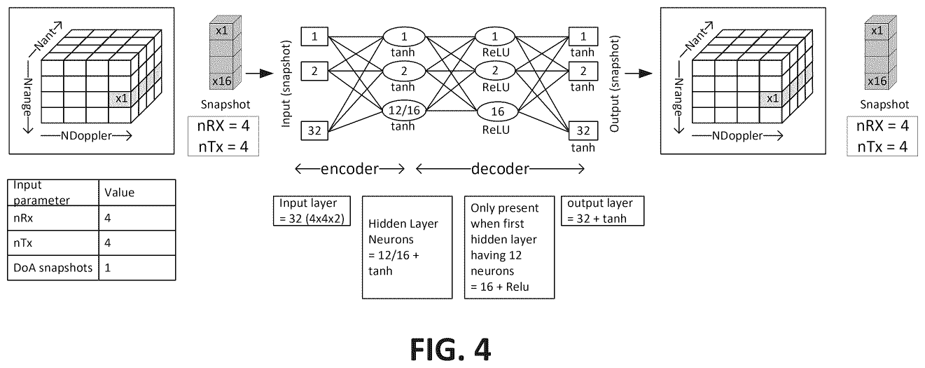

FIG. 4 also illustrates mathematical explanation for the encoding and decoding operations performed between two layers of a neural network. Specifically, the example shows an input layer and a first hidden layer for encoding, and a first hidden layer and output layer for decoding. An input vector has elements i1 . . . i32 (32 elements in total). These elements can equate to 16 elements of a vector from the 3D radar cube, wherein those 16 vector elements corre unit Rx antenna and Tx antenna combination. For example, in a system with 4 Tx antennas and 4 Rx antennas, the first vector element can correspond to RX1 and Tx1, then second vector element can correspond to Rx1 and Tx2, the third vector element can correspond to Rx1 and Tx3, . . . , the fifth vector element can corresond to Rx2 and Tx3, and so on, up to the sixteen vector element at Rx4 and Tx4. Further, each vector element can be a complex number with a real component and and imaginary component, which gives rise to the 32 vector elements at the input layer. For the encoding side, after the matrix vector operations the result vector is ha1 . . . ha16 (16 elements). So with this example if ha are stored in the memory instead of i vector we can get the compression ratio of 2:1. For the example where ha vector will have e.g. 12 elements, the W matrix and b vector dimention will be updated accordingly. W (trained weights matrix) and b (trained bias vector) which we typically update during the training phase and during deployment they remain static. Similarly, for decoder side the appropriate dimention of W matrix and b vector can grow hidden layer back to the required dimension of output.

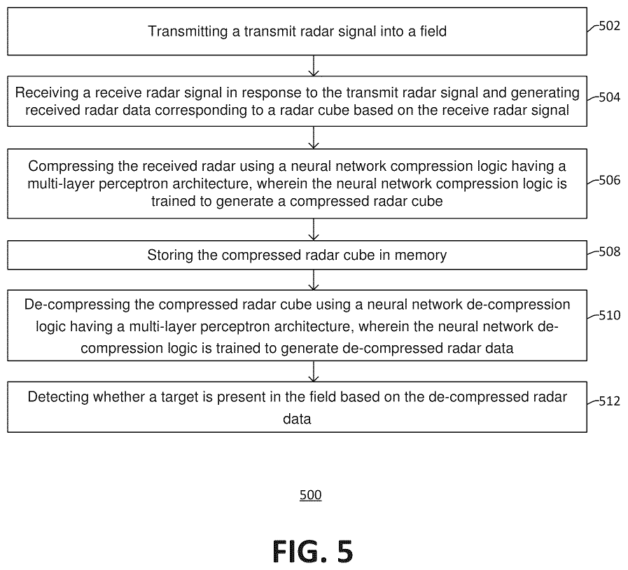

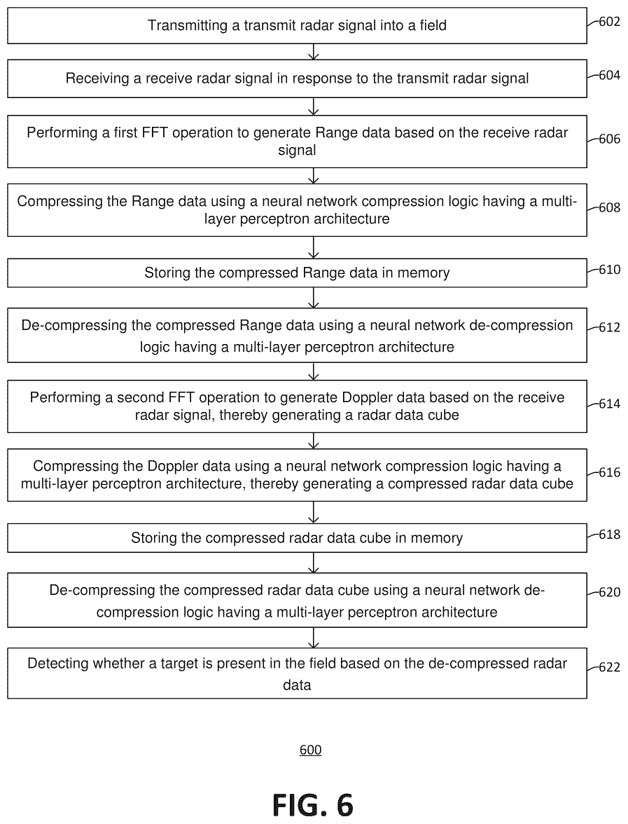

With reference to FIG. 5 and FIG. 6, flow charts of methods in accordance with some aspects are provided. Although FIGS. 5 and 6 are described as a series of acts, it will be appreciated that these acts are not limiting in that the order of the acts can be altered in other embodiments, and the methods disclosed are also applicable to other methods. In other embodiments, some acts that are illustrated and/or described may be omitted in whole or in part.

In FIG. 5's method 500, a transmit radar signal is transmitted into a field at 502. At 504, a receive radar signal is received in response to the transmit radar signal and a received radar data is generated based on the receive radar signal. The received radar data corresponds to a radar cube. At 506, the received radar is compressed using a neural network compression logic having a multi-layer perceptron architecture. The neural network compression logic is trained to generate a compressed radar cube. At 508, the compressed radar cube is stored in memory. At 510, the compressed radar cube is then de-compressed using a neural network de-compression logic having a multi-layer perceptron architecture. The neural network de-compression logic is trained to generate de-compressed radar data. At 512, the method then detects whether a target is present in the field based on the de-compressed radar data.

In FIG. 6's method 600, at 602 a transmit radar signal is transmitted into a field. AT 604, a receive radar signal is received in response to the transmit radar signal. AT 606, a first FFT (or DFT) operation is performed to generate Range data based on the receive radar signal. At 608, the Range data is compressed using a neural network compression logic having a multi-layer perceptron architecture. At 610, the compressed Range data is stored in memory. At 612, the compressed Range data is de-compressed using a neural network de-compression logic having a multi-layer perceptron architecture. At 614, a second FFT (or DFT) operation is used to generate Doppler data based on the receive radar signal, thereby generating a radar data cube. At 616, the Doppler data is compressed using a neural network compression logic having a multi-layer perceptron architecture, thereby generating a compressed radar data cube. At 618, the compressed radar data cube is stored in the memory. At 620, the compressed radar data cube is decompressed using a neural network de-compression logic having a multi-layer perceptron architecture. At 622, the method detects whether a target is present in the field based on the de-compressed radar data.

Thus, some examples relate to a radar system including a radar transmitter including a number of transmit antennas configured to transmit a transmit radar signal into a field. A radar receiver includes a number of receive antennas configured to receive a receive radar signal in response to the transmit radar signal and generate received radar data based on the receive radar signal. A neural network compression logic is coupled to the radar receiver and has a multi-layer perceptron architecture. The neural network compression logic is trained to compress the received radar data to generate a compressed radar cube. A memory is coupled to the neural network compression logic and is configured to store the compressed radar cube. A neural network de-compression logic is coupled to the memory and has a multi-layer perceptron architecture. The neural network de-compression logic is trained to de-compress the compressed radar cube to generate de-compressed radar data. A target detection logic is coupled to the neural network de-compression logic and is configured to detect whether a target is present in the field based on the de-compressed radar data.

In some examples, the neural network compression logic comprises an input layer coupled to the radar receiver, an output layer coupled to the memory, and a hidden layer coupled between the input layer of the neural network compression logic and the output layer of the neural network compression logic. The hidden layer of the neural network compression logic has fewer nodes than the input layer of the neural network compression logic and more nodes than the output layer of the neural network compression logic.

In some examples, the input layer of the neural network compression logic has a number of nodes based on the number of transmit antennas multiplied by the number of receive antennas.

In some examples, the number of nodes for the input layer of the neural network compression logic is equal to the number of transmit antennas multiplied by the number of receive antennas multiplied by two.

In some examples, the neural network de-compression logic comprises an input layer coupled to the memory, an output layer coupled to the target detection logic, and a hidden layer coupled between the input layer of the neural network de-compression logic and the output layer of the neural network de-compression logic. The hidden layer of the neural network de-compression logic has more nodes than the input layer of the neural network de-compression logic and fewer nodes than the output layer of the neural network de-compression logic.

In some examples, the radar system also includes a Range fast Fourier transform (FFT) circuit having an input coupled to an output of the radar receiver and having an output coupled to the neural network compression logic.

In some examples, the Range FFT circuit is configured to generate a plurality of complex coordinate pairs for a plurality of range bins, respectively.

In some examples, the radar system also includes a Doppler FFT circuit having an input coupled to an output of the neural network de-compression logic and having an output coupled to the target detection logic.

In some examples, the radar system includes a Doppler FFT circuit having an input and an output, wherein the input of the Doppler FFT circuit is coupled to an output of the neural network de-compression logic and configured to generate a plurality of Range, Doppler coordinate pairs for a plurality of Doppler bins, respectively.

In some examples, the radar system further includes a second neural network compression logic having an input coupled to the output of the Doppler FFT circuit and having an output coupled to the memory, and configured to generate a plurality of compressed Range, Doppler coordinate pairs based on the plurality of Range, Doppler coordinate pairs, respectively. The radar system can also include a second neural network de-compression logic having an input coupled to the memory and an output coupled to the target detection logic, the second neural network decompression logic configured to de-compress the plurality of compressed Range, Doppler coordinate pairs.

In some examples, a method includes acts of transmitting a transmit radar signal into a field, and receiving a receive radar signal in response to the transmit radar signal and generating received radar data corresponding to a radar cube based on the receive radar signal. The received radar data is compressed using a neural network compression logic having a multi-layer perceptron architecture, wherein the neural network compression logic is trained to generate a compressed radar cube based on the received radar signal. The compressed radar cube is stored in memory. The compressed radar cube is stored using a neural network de-compression logic having a multi-layer perceptron architecture, wherein the neural network de-compression logic is trained to generate de-compressed radar data. The method detects whether a target is present in the field based on the de-compressed radar data.

In some examples, the neural network compression logic comprises an input layer, an output layer, and a hidden layer coupled between the input layer and the output layer, the hidden layer having fewer nodes than the input layer and more nodes than the output layer.

In some examples, the transmit radar signal is transmitted using a number of transmit antennas, and the receive radar signal is received using a number of receive antennas; and wherein the output layer of the neural network compression logic has a number of nodes that is based on a product of the number of transmit antennas multiplied by the number of receive antennas.

In some examples, the number of nodes for the output layer is equal to the number of transmit antennas multiplied by the number of receive antennas multiplied by two.

Some other examples relate to a method that includes the acts of transmitting a transmit radar signal into a field, and receiving a receive radar signal in response to the transmit radar signal. A first FFT operation is performed to generate Range data based on the receive radar signal, and the Range data is compressed using a neural network compression logic having a multi-layer perceptron architecture. The compressed Range data is stored in a memory. The compressed Range data is de-compressed using a neural network de-compression logic having a multi-layer perceptron architecture. A second FFT operation is then performed to generate Doppler data based on the receive radar signal, thereby generating a radar data cube. The Doppler data is then compressed using a neural network compression logic having a multi-layer perceptron architecture, thereby generating a compressed radar data cube. The compressed radar data cube is stored in the memory. The compressed radar data cube is then de-compressed using a neural network de-compression logic having a multi-layer perceptron architecture. The method detects whether a target is present in the field based on the de-compressed radar data.

In some examples, the neural network compression logic comprises an input layer, an output layer, and a hidden layer coupled between the input layer and the output layer. The hidden layer has fewer nodes than the input layer and more nodes than the output layer.

In some examples, the transmit radar signal is transmitted using a number of transmit antennas, and the receive radar signal is received using a number of receive antennas; and wherein the input layer of the neural network compression logic has a number of nodes based on a product of the number of transmit antennas multiplied by the number of receive antennas.

In some examples, the number of nodes for the input layer is equal to the number of transmit antennas multiplied by the number of receive antennas multiplied by two.

In some examples, the neural network de-compression logic comprises an input layer, an output layer, and a hidden layer coupled between the input layer of the neural network de-compression logic and the output layer of the neural network de-compression logic.

In some examples, the input layer of the neural network compression logic has a first number of nodes and the output layer of the neural network de-compression logic has a second number of nodes, the second number being equal to the first number.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A radar system comprising:
a radar transmitter including a number of transmit antennas configured to transmit a transmit radar signal into a field;
a radar receiver including a number of receive antennas configured to receive a receive radar signal in response to the transmit radar signal and generate received radar data based on the receive radar signal;
a neural network compression logic coupled to the radar receiver and having a multi-layer perceptron architecture, wherein the neural network compression logic is trained to compress the received radar data to generate a compressed radar cube;
a memory coupled to the neural network compression logic and configured to store the compressed radar cube;
a neural network de-compression logic coupled to the memory and having a multi-layer perceptron architecture, wherein the neural network de-compression logic is trained to de-compress the compressed radar cube to generate de-compressed radar data; and
a target detection logic coupled to the neural network de-compression logic and configured to detect whether a target is present in the field based on the de-compressed radar data.

2. The radar system of claim 1, wherein the neural network compression logic comprises an input layer coupled to the radar receiver, an output layer coupled to the memory, and a hidden layer coupled between the input layer of the neural network compression logic and the output layer of the neural network compression logic, the hidden layer of the neural network compression logic having fewer nodes than the input layer of the neural network compression logic and more nodes than the output layer of the neural network compression logic.

3. The radar system of claim 2, wherein the input layer of the neural network compression logic has a number of nodes based on the number of transmit antennas multiplied by the number of receive antennas.

4. The radar system of claim 3, the number of nodes for the input layer of the neural network compression logic is equal to the number of transmit antennas multiplied by the number of receive antennas multiplied by two.

5. The radar system of claim 1, wherein the neural network de-compression logic comprises an input layer coupled to the memory, an output layer coupled to the target detection logic, and a hidden layer coupled between the input layer of the neural network de-compression logic and the output layer of the neural network de-compression logic, the hidden layer of the neural network de-compression logic having more nodes than the input layer of the neural network de-compression logic and fewer nodes than the output layer of the neural network de-compression logic.

6. The radar system of claim 1, further comprising:
a Range fast Fourier transform (FFT) circuit having an input coupled to an output of the radar receiver and having an output coupled to the neural network compression logic.

7. The radar system of claim 6, wherein the Range FFT circuit is configured to generate a plurality of complex coordinate pairs for a plurality of range bins, respectively.

8. The radar system of claim 6, further comprising:
a Doppler FFT circuit having an input coupled to an output of the neural network de-compression logic and having an output coupled to the target detection logic.

9. The radar system of claim 6, further comprising:
a Doppler FFT circuit having an input and an output, wherein the input of the Doppler FFT circuit is coupled to an output of the neural network de-compression logic and configured to generate a plurality of Range, Doppler coordinate pairs for a plurality of Doppler bins, respectively.

10. The radar system of claim 9, further comprising:
a second neural network compression logic having an input coupled to the output of the Doppler FFT circuit and having an output coupled to the memory, and configured to generate a plurality of compressed Range, Doppler coordinate pairs based on the plurality of Range, Doppler coordinate pairs, respectively; and
a second neural network de-compression logic having an input coupled to the memory and an output coupled to the target detection logic, the second neural network decompression logic configured to de-compress the plurality of compressed Range, Doppler coordinate pairs.

11. A method, comprising:
transmitting a transmit radar signal into a field;
receiving a receive radar signal in response to the transmit radar signal and generating received radar data corresponding to a radar cube based on the receive radar signal;
compressing the received radar data using a neural network compression logic having a multi-layer perceptron architecture, wherein the neural network compression logic is trained to generate a compressed radar cube based on the received radar signal;
storing the compressed radar cube in memory;
de-compressing the compressed radar cube using a neural network de-compression logic having a multi-layer perceptron architecture, wherein the neural network de-compression logic is trained to generate de-compressed radar data; and
detecting whether a target is present in the field based on the de-compressed radar data.

12. The method of claim 11, wherein the neural network compression logic comprises an input layer, an output layer, and a hidden layer coupled between the input layer and the output layer, the hidden layer having fewer nodes than the input layer and more nodes than the output layer.

13. The method of claim 12, wherein the transmit radar signal is transmitted using a number of transmit antennas, and the receive radar signal is received using a number of receive antennas; and wherein the output layer of the neural network compression logic has a number of nodes that is based on a product of the number of transmit antennas multiplied by the number of receive antennas.

14. The method of claim 13, wherein the number of nodes for the output layer is equal to the number of transmit antennas multiplied by the number of receive antennas multiplied by two.

15. A method, comprising:
transmitting a transmit radar signal into a field;
receiving a receive radar signal in response to the transmit radar signal;
performing a first FFT operation to generate Range data based on the receive radar signal;
compressing the Range data using a neural network compression logic having a multi-layer perceptron architecture;
storing the compressed Range data in a memory;
de-compressing the compressed Range data using a neural network de-compression logic having a multi-layer perceptron architecture;
performing a second FFT operation to generate Doppler data based on the receive radar signal, thereby generating a radar data cube;
compressing the Doppler data using a neural network compression logic having a multi-layer perceptron architecture, thereby generating a compressed radar data cube;
storing the compressed radar data cube in the memory;
de-compressing the compressed radar data cube using a neural network de-compression logic having a multi-layer perceptron architecture; and
detecting whether a target is present in the field based on the de-compressed radar data.

16. The method of claim 15, wherein the neural network compression logic comprises an input layer, an output layer, and a hidden layer coupled between the input layer and the output layer, the hidden layer having fewer nodes than the input layer and more nodes than the output layer.

17. The method of claim 16, wherein the transmit radar signal is transmitted using a number of transmit antennas, and the receive radar signal is received using a number of receive antennas; and wherein the input layer of the neural network compression logic has a number of nodes based on a product of the number of transmit antennas multiplied by the number of receive antennas.

18. The method of claim 17, wherein the number of nodes for the input layer is equal to the number of transmit antennas multiplied by the number of receive antennas multiplied by two.

19. The method of claim 16, wherein the neural network de-compression logic comprises an input layer, an output layer, and a hidden layer coupled between the input layer of the neural network de-compression logic and the output layer of the neural network de-compression logic.

20. The method of claim 19, wherein the input layer of the neural network compression logic has a first number of nodes and the output layer of the neural network de-compression logic has a second number of nodes, the second number being equal to the first number.
